(19) United States
(12) Patent Application Publication
(10) Pub. No.: US 2011/0043674 A1
(43) Pub. Date: Feb. 24, 2011

(54) PHOTOGRAPHING APPARATUS AND METHOD

(75) Inventor: Yasuo Takane, Yokohama (JP)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Electronics Co., Ltd., Suwon-si (KR)

(21) Appl. No.: 12/859,818

(22) Filed: Aug. 20, 2010

(30) Foreign Application Priority Data
Aug. 21, 2009 (JP) 2009-192625
Dec. 7, 2009 (KR) 10-2009-0120712

(51) Int. Cl. H04N 5/335

(52) U.S. Cl. 348/296; 348/E05.037

(57) ABSTRACT

A photographing apparatus includes an imaging unit having a plurality of pixels arranged in rows and columns and that captures an image of a subject; a detector that detects a photographing condition of the subject; a mechanical shutter that moves to shield the imaging unit; an operation controller that controls movement of the mechanical shutter; and a scan controller that controls an exposure start scan of the imaging unit by applying reset signals to the pixels at a time controlled based on the photographing condition of the subject before the mechanical shutter moves to shield the imaging unit.

### CROSS-REFERENCE TO RELATED PATENT APPLICATION

This application claims the priority benefit of Japanese Patent Application No. 2009-192625, filed on Aug. 21, 2009, in the Japan Patent Office and Korean Patent Application No. 10-2009-0120712, filed on Dec. 07, 2009, in the Korean Intellectual Property Office, the disclosures of which are incorporated herein in their entireties by reference.

### BACKGROUND

1. Field of the Invention

Embodiments relate to a photographing apparatus and method, and more particularly, to a photographing apparatus and method including an imaging unit having a plurality of pixels arranged in a matrix form.

2. Description of the Related Art

Japanese Patent Application Publication JP P1999-41523 (Cited reference 1) discloses a photographing apparatus including an imaging unit having the form of a complementary metal oxide semiconductor (CMOS) in which a front curtain shutter for performing a shutter operation is constituted as an electronic shutter and a rear curtain shutter for performing the shutter operation is constituted as a mechanical shutter.

Also, Japanese Patent Application Publication JP P2007-159061 (Cited reference 2) and Japanese Patent Application Publication JP P2007-53742 (Cited reference 3) disclose technology for preventing exposure stains formed due to a difference in the type of a lens, the value of an iris diaphragm or the speed of a shutter by changing a time at which accumulation of electric charges starts in each region or line of an imaging unit when an electronic shutter and a mechanical shutter are combined with each other.

Cited references 2 and 3 provide technology for correcting the side effect of image quality that occurs when a conventional mechanical front curtain shutter is realized by performing an electronic reset function. However, a time at which the electronic shutter for performing the function of the front curtain shutter starts operating is set so that the electronic shutter may have the same characteristic as that of the mechanical shutter for performing the function of the rear curtain shutter.

The dynamic range of the imaging unit is generally small and thus, it is not easy to capture a dark portion and a bright portion of an image completely. For example, when a portrait is taken in the background of the bright blue sky, if exposure is adjusted to the portrait, the sky that is the background may be saturated in white and thus the blue sky cannot be reproduced. On the other hand, if exposure is adjusted to the blue sky, due to the lack of exposure, the portrait may be squashed in black.

In the above-described cited references 1, 2, and 3, both the electronic shutter and the mechanical shutter are used, and the time at which the electronic shutter for performing the function of the front curtain shutter starts operating is set so that the electronic shutter may have the same characteristic as that of the mechanical shutter for performing the function of the rear curtain shutter. Thus, dynamic ranges of conventional photographing apparatuses are small.

### SUMMARY

Embodiments include a photographing apparatus and method by which an image of good quality can be captured in a wide dynamic range.

Embodiments also include a photographing apparatus and method by which both an electronic shutter and a mechanical shutter are used and a time at which operations of the electronic shutter and the mechanical shutter starts is controlled so that the photographing apparatus has a wide dynamic range.

According to an embodiment, a photographing apparatus includes an imaging unit that captures an image of a subject, the imaging unit comprising a plurality of pixels arranged in rows and columns; a detector that detects a photographing condition of the subject; a mechanical shutter that moves to shield the imaging unit; an operation controller that controls movement of the mechanical shutter; and a scan controller that controls an exposure start scan of the imaging unit by applying reset signals to the pixels at a time controlled based on the photographing condition of the subject before the mechanical shutter moves to shield the imaging unit.

The scan controller may set scan patterns for the photographing condition that is detected by the detector from predetermined scan patterns to correspond to the photographing condition and may apply reset signals to the pixels via the set scan patterns.

According to the above configuration, after applying reset signals to the pixels at a time controlled based on the photographing conditions of the subject, the mechanical shutter moves to shield the imaging device. Thus, exposure start timing of the imaging device may be adjusted according to the photographing conditions, and the photographing apparatus may perform a photographing operation with a wide dynamic range.

The imaging unit may serve as a front curtain shutter by starting exposure according to the reset signals applied by the scan controller to the pixels of the imaging unit, and the mechanical shutter may serve as a rear curtain shutter for shielding the imaging unit.

The photographing conditions of the subject may include light intensity of the lens, a focal distance, an iris value, and brightness distribution of the subject. The photographing apparatus may use the electronic front curtain shutter and the mechanical rear curtain shutter together and control the timing of the electronic front curtain shutter based on the photographing conditions, and thus, may adjust the exposure time.

The detector may detect brightness of the subject, may set the scan patterns in a region in which detected brightness is higher than an upper limit value of a dynamic range of the imaging unit so that a time difference between the front curtain shutter and the rear curtain shutter is decreased, and may set the scan patterns in a region in which detected brightness is lower than a lower limit value of the dynamic range of the imaging unit so that a time difference between the front curtain shutter and the rear curtain shutter is increased. Therefore, when the photographing conditions of the subject exceeds the upper limit of the dynamic range, that is, when the image is saturated as white or smeared as black, an exposure start timing of the imaging device may be adjusted.

The operation controller may move the mechanical shutter in a direction that crosses a direction in which a row formed by the pixels extends, and the scan patterns may include a characteristic curve for representing an exposure start time of each of the rows from rows of the pixels that correspond to a position in which the mechanical shutter starts moving to rows of the pixels that correspond to a position in which the mechanical shutter terminates moving. Thus, the exposure of the imaging device may be started based on the characteristic curve representing the exposure start time of the imaging device.

The characteristic curve may be generated by a function for determining an exposure start time of each of the rows from rows of the pixels that correspond to a position in which the mechanical shutter starts moving to rows of the pixels that correspond to a position in which the mechanical shutter terminates moving. The photographing apparatus may start exposure of the imaging device based on the function determining the exposure start time. The function may be a primary function or a secondary function.

The scan controller may divide the imaging unit into a plurality of regions and sequentially start exposure of the divided regions.

The scan controller may control a read scan for reading an output signal of each of the pixels of the imaging unit, and the apparatus may further include a gain controller that controls gain of the output signal of each of the pixels in synchronization with an operation of reading rows of the pixels via the scan controller.

The gain controller may control the gain of the output signal in units of the pixels of the imaging unit by referring to a parameter table for representing gain control values respectively corresponding to the rows of the pixels. Thus, the photographing apparatus may adjust gain in the horizontal direction in which rows of the pixels extend.

The gain controller may control the gain of the output signal in units of the pixels of the imaging unit based on a function for representing a width of variation of the gain to correspond to the rows of the pixels.

According to another embodiment, a photographing method, for capturing an image of a subject by exposing an imaging unit comprising a plurality of pixels arranged in rows and columns, includes detecting a photographing condition of the subject; performing an exposure start scan by applying reset signals to the pixels at a time controlled based on the photographing condition of the subject and operating a front curtain shutter; moving a mechanical shutter to shield the pixels to which the reset signals are applied and operate as a rear curtain shutter.

According to the photographing apparatus and method, both an electronic shutter and a mechanical shutter are used and times at which operations of the electronic shutter and the mechanical shutter start are controlled so that the photographing apparatus has a wide dynamic range.

### BRIEF DESCRIPTION OF THE DRAWINGS

The above and other features and advantages will become more apparent by describing in detail exemplary embodiments with reference to the attached drawings in which:

FIG. 1 illustrates three images for explaining the concept of a photographing operation to be performed by a photographing apparatus and method according to an embodiment;

FIG. 2 is a graph showing operating patterns of mechanical shutters including a front curtain shutter and a rear curtain shutter in a conventional photographing apparatus, according to distance and time;

FIG. 3 is a graph showing operating patterns of an electronic front curtain shutter and a mechanical rear curtain shutter in the photographing apparatus of FIG. 1, according to distance and time;

FIG. 4 is a schematic block diagram of elements of a photographing apparatus according to an embodiment;

FIG. 5 is a schematic block diagram of the structure of a central processing unit (CPU) and the connection relationship between other elements of the photographing apparatus of FIG. 4;

FIG. 6 illustrates an example of detecting a photographing condition of an imaging scene that is displayed by the photographing apparatus of FIG. 1;

FIG. 7 illustrates another example of detecting a photographing condition of a scene to be captured, which is displayed by the photographing apparatus of FIG. 1;

FIG. 8 is a graph showing a gain controlling operation and an electronic front curtain shutter controlling operation, which are performed by the photographing apparatus of FIG. 1;

FIG. 9 is a flowchart illustrating a photographing method according to an embodiment;

FIG. 10 is a flowchart illustrating a photographing method according to another embodiment; and

FIG. 11 is a flowchart illustrating operations of the photographing method of FIG. 10.

### DETAILED DESCRIPTION

Embodiments will now be described more fully with reference to the accompanying drawings, in which exemplary embodiments are shown.

In a conventional photographing apparatus, even when an electronic front curtain shutter and a mechanical rear curtain shutter are used, a time at which the electronic front curtain shutter starts operating is set so that the electronic front curtain shutter may have the same operating characteristic as that of the mechanical rear curtain shutter, and thus, the dynamic range of the photographing apparatus is limited.

However, in a photographing apparatus according to an embodiment, both an electronic shutter and a mechanical shutter are used, and a time (exposure time) at which accumulation of electric charges starts may be varied in each region or each row (pixel line) of pixels of an imaging unit. In other words, the exposure time may be varied in each region or each pixel line of the imaging unit and thus a photographing apparatus and method having a wide dynamic range may be achieved.

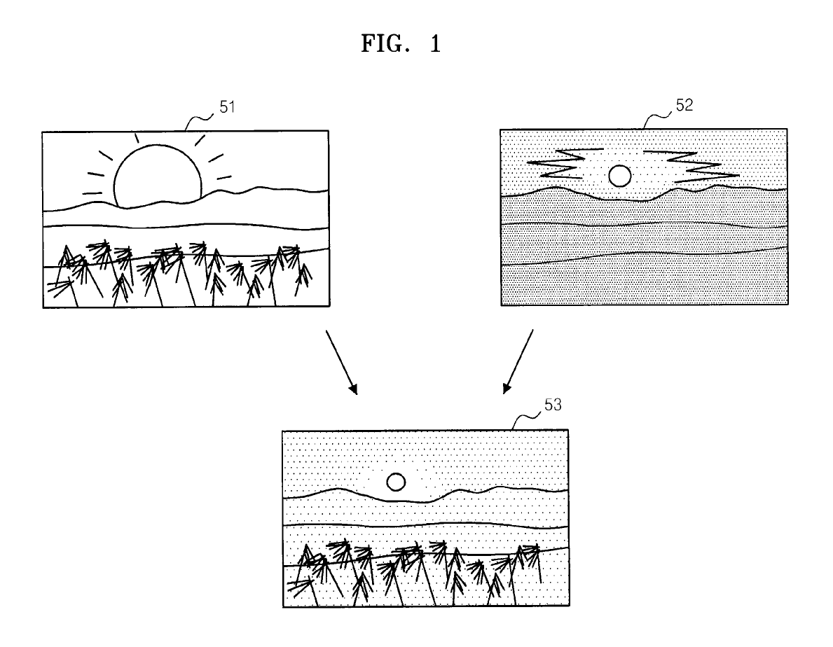

FIG. 1 illustrates three images for explaining the concept of a photographing operation to be performed by a photographing apparatus and method according to an embodiment. Referring to FIG. 1, images 51 and 53 are images that are captured from landscape including the sun, a mountain, and flame grass. The image 51 is captured while exposure is adjusted to a lower portion of the image 51. In the image 51, the flame grass shown in the lower portion of the image 51 is well captured but an ambient portion of the sun shown in an upper portion of the image 51 is saturated in white.

An image 52 is captured from the same landscape as that of the image 51 while exposure is adjusted to the sun shown in the upper portion of the image 52. In the image 52, the sun shown in the upper portion of the image 52 is well captured but the flame grass shown in the lower portion of the image 52 is squashed in black due to the lack of exposure.

The image 53 is captured while exposure is adjusted by the photographing apparatus according to the current embodiment. In the image 53, the ambient portion of the sun includes less white portion than that of the image 51, and the lower portion of the image 53 includes less black portion than that of the image 52 so that the sun, the mountain, and the flame grass included in the landscape may be well captured.

In the photographing apparatus according to the present embodiment, both the electronic shutter and the mechanical shutter are used, and the time at which the electronic shutter (electronic front curtain shutter) starts operating may be controlled so that the exposure time may be controlled in each region or each pixel line of the imaging unit and good photographing may be performed.

In detail, in the photographing apparatus according to the present embodiment, an image to be captured is divided into regions, and the distribution of brightness in each region is detected so that a captured image (scene) may be analyzed. Parameters of a time table, in which the operating time of the electronic front curtain shutter is written, may be varied or a function for generating the parameters may be varied based on a measured exposure value in each region of an image to be captured so that the exposure time in the image to be captured may be adjusted according to a photographing condition of the image to be captured.

For example, brightnesses of the upper and lower portions of the image 53 are different. In detail, the upper portion of the image 53 is bright, and the lower portion thereof is dark. Thus, the photographing apparatus changes the operating time of the electronic front curtain shutter so that the exposure time may be decreased in the upper portion of an image to be captured and the exposure time may be increased in the lower portion of the image to be captured.

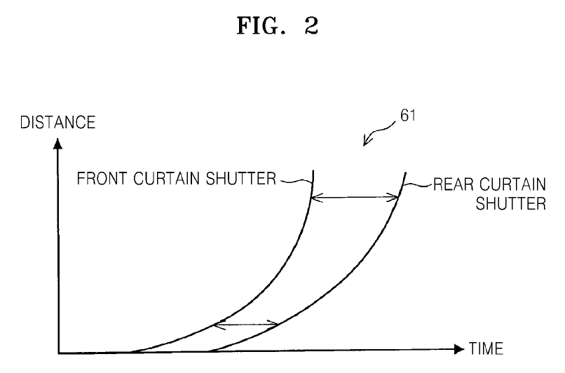

FIG. 2 is a graph showing operating patterns of mechanical shutters including a front curtain shutter and a rear curtain shutter in a conventional photographing apparatus, according to distance and time. In graph 61 of FIG. 2, the latitudinal axis represents time, and the longitudinal axis represents distance (position) from a lower end of an imaging unit.

As shown in graph 61 of FIG. 2, the moving speed of the mechanical shutter is not uniform. In detail, the moving speed of the mechanical shutter is comparatively low in a portion in which the mechanical shutter starts moving, and the mechanical shutter is accelerated as it gets closer to a portion in which moving of the mechanical shutter is finished, and the moving speed of the mechanical shutter is comparatively high. The moving speed of the mechanical shutter may also be varied due to a change of temperature or humidity, a change of the position of the photographing apparatus or the like.

Thus, when an electronic shutter is used as the front curtain shutter, the moving speed of the electronic front curtain shutter is uniformly maintained, and the moving speed of the mechanical rear curtain shutter is varied so that a severe difference between the moving speed of the electronic front curtain shutter and the moving speed of the mechanical rear curtain shutter may occur.

When the electronic shutter is used as the front curtain shutter, reset signals that are used to perform a reset operation are sequentially provided to each pixel of the imaging unit in the unit of a pixel line so that an exposure operation may start from the imaging unit. Mechanical shielding that is performed by moving a shield (rear curtain shutter) is performed after the set exposure time has been elapsed, so that the exposure operation of the imaging unit may be terminated.

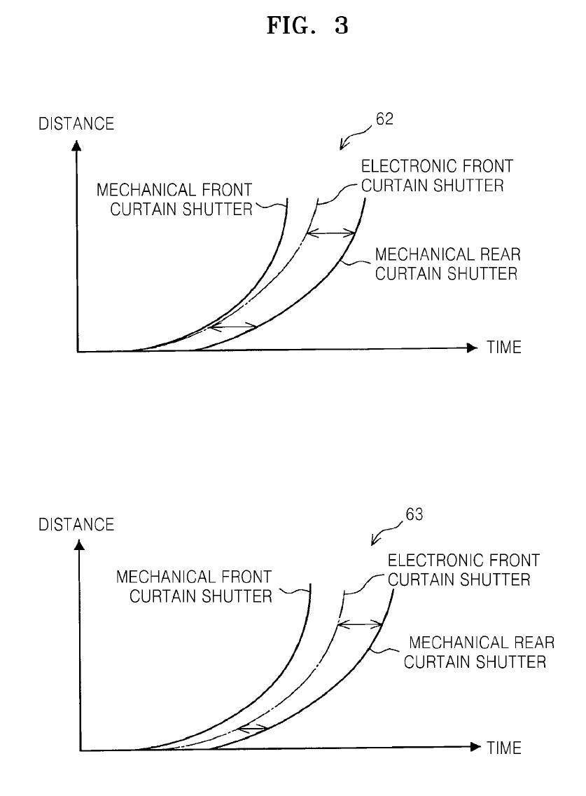

FIG. 3 is a graph showing operating patterns of the electronic front curtain shutter and the mechanical rear curtain shutter in the photographing apparatus of FIG. 1, according to distance and time. In FIG. 3, upper graph 62 illustrates the relationship between reset scan patterns of the electronic front curtain shutter and moving patterns of the mechanical rear curtain shutter.

As shown in graph 62, in order to prevent a difference between the moving speed of the electronic front curtain shutter and the moving speed of the mechanical rear curtain shutter, a scan curve of reset scan (exposure start scan) of the electronic front curtain shutter has nearly the same shape as that of a driving curve of the mechanical rear curtain shutter. In detail, nearly the same exposure time may be applied to upper and lower portions of the imaging unit.

In FIG. 3, lower graph 63 illustrates the relationship between scan patterns of the electronic front curtain shutter and moving patterns of the mechanical rear curtain shutter that are adjusted based on the photographing condition for the photographing apparatus of FIG. 1.

The photographing apparatus detects a white-saturated region, a black-squashed region or the like from an image to be captured, based on a measured exposure value in each region or each pixel line of the imaging unit. The exposure time of the imaging unit may be adjusted according to the result of detecting.

For example, in lower graph 63 of FIG. 3, the exposure time is set to be decreased in a portion in which the shutter starts moving, and the exposure time is set to be increased in a portion in which moving of the shutter is terminated. This is because the photographing apparatus has the photographing condition in which the upper portion of an image to be captured is bright and the lower portion thereof is dark and thus the exposure time of the upper portion of the image to be captured is decreased and the exposure time of the lower portion of the image to be captured is increased by varying scan patterns of the electronic front curtain shutter of the graph 63 based on the photographing condition. In this way, in the present embodiment, an exposure start scan time may be adjusted according to the photographing condition of the image to be captured so that the photographing apparatus and method having a wide dynamic range may be achieved.

The photographing apparatus according to the present invention may vary sensitivity (gain) partially based on the measured exposure value in each region of the image to be captured. For example, in consideration of the ratio of the white-saturated region and the black-squashed region of the image to be captured, contrast or each position of the white-saturated region and the black-squashed region of the image to be captured, the exposure time may be adjusted by the electronic front curtain shutter in each divided region of the image to be captured, or sensitivity (gain) may be varied, or the exposure time may be adjusted and sensitivity (gain) may be varied. Thus, a good-quality image may be obtained in the wide dynamic range of the photographing apparatus.

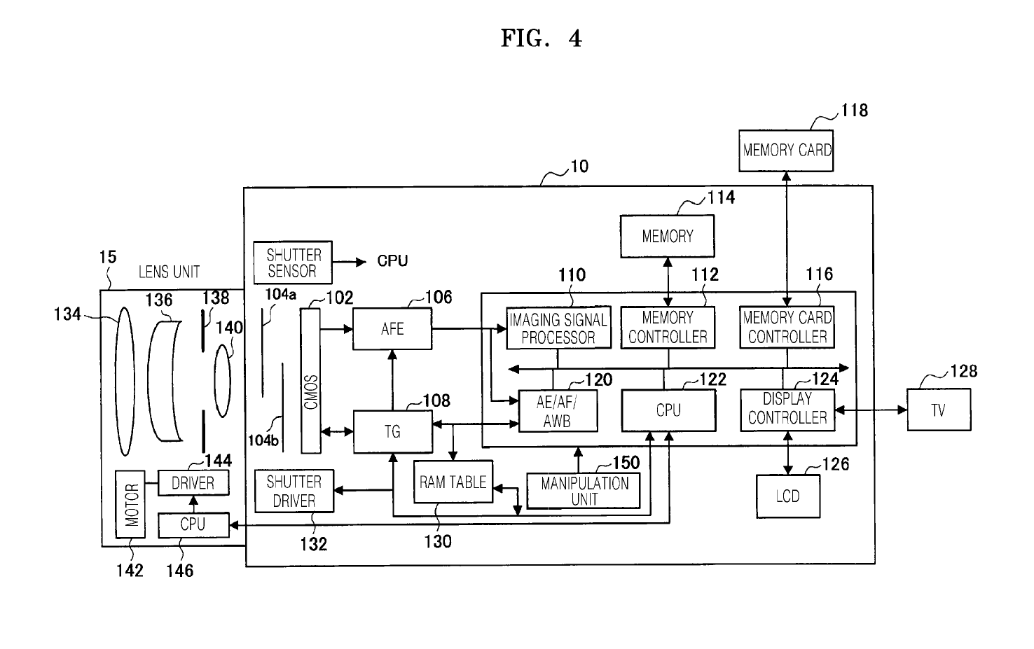

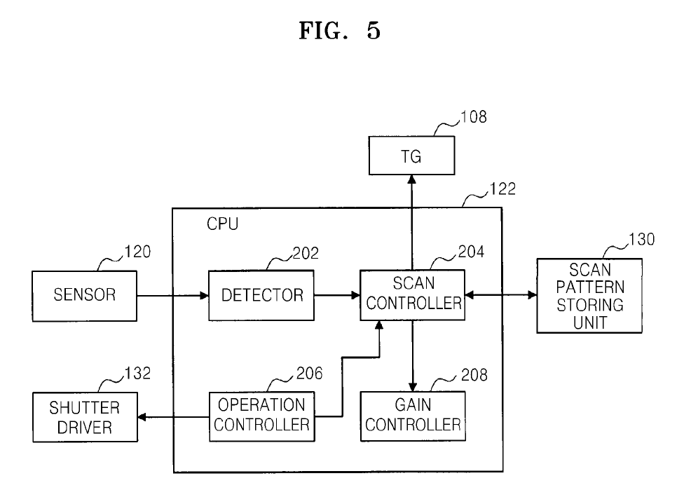

FIG. 4 is a schematic block diagram of elements of a photographing apparatus 10 according to an embodiment, and FIG. 5 is a schematic block diagram of the structure of a central processing unit (CPU) 122 and the connection relationship between other elements of the photographing apparatus of FIG. 4.

The photographing apparatus 10 of FIGS. 4 and 5 includes a complementary metal oxide semiconductor (CMOS) 102 that is a type of an imaging unit, a detector 202, shutters 104a and 104b that are a type of a mechanical shutter, a shutter driver 132 that is a type of an operation controller for controlling the mechanical shutter, and a scan controller 204.

The photographing apparatus 10 may include the CMOS 102, the shutters 104a and 104b (hereinafter, referred to as a shutter unit 104), an analog front end (AFE) 106, a timing generator (TG) 108, an imaging signal processor 110, a memory controller 112, a memory 114, a memory card controller 116, an AE/AF/AWB 120, a CPU 122, a display controller 124, a liquid crystal display (LCD) 126, a random access memory (RAM) table 130, a shutter driver 132, and a lens unit 15.

The CMOS 102 is a type of an imaging unit that includes a plurality of pixels arranged in a matrix form including rows and columns and that converts light that is incident through the lens unit 15 into an electrical signal. The CMOS 102 converts light of an image of a subject formed by the lens unit 15 into an analog electrical signal (image signal) having each color component, such as red (R), green (G) or blue (B), and outputs an image signal of each color such as R, G or B. In the present embodiment, a reset signal is applied to each of the pixels of the CMOS 102 for a predetermined amount of time, thereby starting the exposure operation of the CMOS 102 so that the CMOS 102 may perform the function of an electronic front curtain shutter.

The shutter unit 104 includes a shield that moves in a direction perpendicular to a predetermined pixel line of the CMOS 102, thereby serving as a rear curtain for performing an operation of blocking light exposed to the CMOS 102. The operation of the shutter unit 104 is controlled by the shutter driver 132.

The AFE 106 is analog front end circuit and provides the analog electrical signal output by the CMOS 102 to the imaging signal processor 110. The TG 108 inputs time signals to the CMOS 102 and the AFE 106. The speed of the shutter unit 104 is determined according to the time signals input by the TG 108. In detail, driving of the CMOS 102 is controlled according to the time signals input by the TG 108, and light of the image of the subject is incident through the lens unit 15 within a time at which the CMOS 102 is driven so that an electrical signal that is a base of image data may be generated.

The imaging signal processor 110 generates raw data of an image that is obtained by converting the analog electrical signal output by the AFE 106 into a digital signal. Also, the imaging signal processor 110 performs gain correction of the amount of light or a white balance setting function with respect to the raw data of the image obtained by the CMOS 102.

The memory controller 112 controls the memory 114 to store the captured image in the memory 114 temporarily or to read the stored image from the memory 114. The memory 114 has a capacity for storing a plurality of images. The memory 114 may be a synchronous dynamic random access memory (SDRAM), for example.

The memory card controller 116 controls a memory card 118 so that a captured or synthesized image may be written in the memory card 118. The memory card 118 is a card type memory unit for writing data in a flash memory.

The AE/AF/AWB 120 detects the ambient amount of light (brightness) or a focal length during photographing, an iris diaphragm value (focus), color temperature or the like and performs a function of providing the result of detecting to the CPU 122. The CPU 122 executes commands of a signal system on the CMOS 102 or the TG 108 or executes commands of a manipulation system on a manipulation unit 150. In the current embodiment, the commands of the signal system and the commands of a scan system are executed by one CPU 122. However, the present embodiment is not limited thereto, and the commands of the signal system and the commands of the scan system may be executed by two CPUs. Controlling of a front curtain via the electronic shutter and a rear curtain via the mechanical shutter to be performed by the CPU 122 will be described later in detail.

The LCD 126 displays a live view image before photographing is performed, or displays various setting scenes of the photographing apparatus 10 or an image captured by the photographing apparatus 10. Also, a television (TV) 128 displays the captured image or the like on a screen of the TV 128. Image data or the like is displayed on the LCD 126 or the TV 128 via the display controller 124.

The RAM table 130 is a table in which a scan table is stored. The plurality of scan patterns are previously stored in the RAM table 130, and scan patterns appropriate to the photographing condition of an image to be captured may be selected. Also, scan patterns that are a reference value may be stored in the RAM table 130, and the scan patterns may be varied according to a difference between the value of the ambient amount of light of the image to be captured and the reference value. The scan patterns are formed at a time at which a reset time (exposure start time) via the electronic front curtain shutter is output. For example, the scan curve shown in graph 63 of FIG. 3 is stored in the scan table.

Also, instead of the RAM table 130 in which the scan patterns are stored, a function generating circuit (not shown) may be used. When the function generating circuit is used, a function may be simply represented as a second-order function or may be correlated as a first-order function. A scan time is output by the function generating circuit so that a necessary capacity of storage may be reduced.

The manipulation unit 150 includes elements for manipulating the photographing apparatus 10 or performing various setting functions during photographing. The elements disposed in the manipulation unit 150 may include a power supply button, a cross key and a selection button for selecting a photographing mode or a photographing driving mode and for setting effect parameters, a shutter button for starting a photographing operation of a subject, or the like.

Next, controlling of the front curtain and the rear curtain via the CPU 122 will be described with reference to FIG. 5. Referring to FIG. 5, the CPU 122 may include the detector 202, the scan controller 204, an operation controller 206, and a gain controller 208.

The detector 202 detects the photographing condition of the subject. In detail, the detector 202 detects the photographing condition of an image to be captured (a captured scene) from the ambient amount of light (brightness), the focal length, the iris diaphragm value, and the color temperature, which are detected by the AE/AF/AWB 120, and detects whether the photographing condition is in the dynamic range of an imaging unit. For example, the detector 202 detects whether brightness of the photographing condition may be reproduced by the white-saturated portion of the image to be captured due to the surplus of exposure or black-squashed portion of the image to be captured due to the lack of exposure.

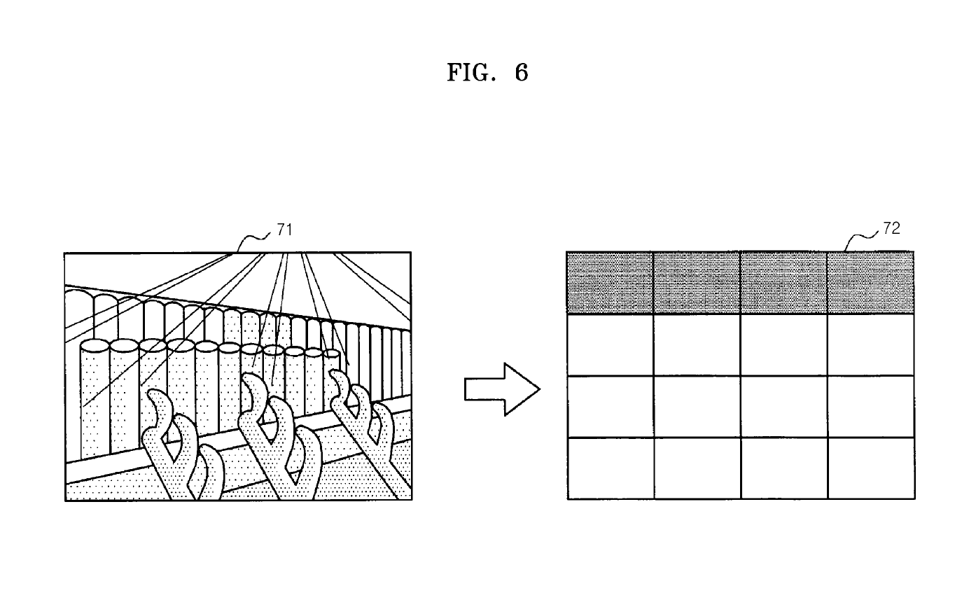

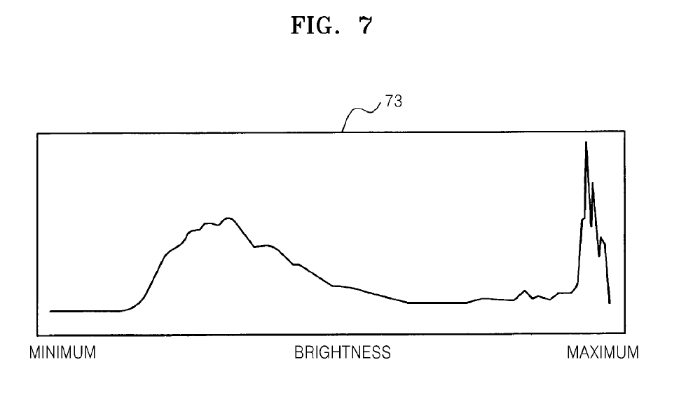

Hereinafter, detecting of the photographing condition via the detector 202 will be described with reference to FIGS. 6 and 7. FIG. 6 illustrates an example of detecting a photographing condition of an imaging scene that is displayed by the photographing apparatus of FIG. 1.

For example, in FIG. 6, an upper portion of an image is saturated in white, and the blue sky is not reproduced. Thus, the detector 202 detects a saturation region from a scene 71 to be captured. For example, as shown in an image 72, the scene 71 to be captured is divided into a predetermined number of regions, thereby detecting the saturation region from the scene 71 to be captured. In this case, the detector 202 detects that four regions of the upper portion of the scene 71 to be captured are the saturation region, i.e., a region that exceeds the upper limit value of the dynamic range of the imaging unit.

FIG. 7 illustrates another example of detecting a photographing condition of a scene to be captured, which is displayed by the photographing apparatus of FIG. 1. Referring to a histogram 73 of FIG. 7, in order to detect the photographing condition of the scene to be captured, a saturation region may be searched for from the scene to be captured. A large peak is displayed on the right side of the histogram 73. In detail, the white saturated region may be included in a portion of the scene to be captured. The photographing apparatus 10 (FIG. 4) controls exposure start scan of the imaging unit via the scan controller 204 (FIG. 5) that will be described later, so that the exposure time in each region or each pixel line of the scene to be captured may be corrected and exposure of the saturation region may be prevented.

Referring back to FIG. 5, a description of the structure of the CPU 122 will be continued. The scan controller 204 controls exposure start scan of the imaging unit (CMOS 102) based on the scan patterns according to the photographing condition detected by the detector 202. Also, the scan controller 204 starts exposure of the CMOS 102 before operating the shutter unit 104 via the operation controller 206 that will be described later.

The scan controller 204 controls the imaging unit to start an exposure operation by sequentially applying reset signals that are used to start exposure by each of the pixels of the imaging unit in the unit of a pixel line. The scan controller 204 may generate scan patterns according to the photographing condition and store the scan patterns in a scan pattern storing unit (RAM table) 130 by adjusting the scan patterns stored in the scan pattern storing unit (RAM table) 130. The scan controller 204 supplies time signals based on the scan patterns to the TG 108 so as to control exposure start scan.

The operation controller 206 performs a function of controlling the operation of the shutter unit 104 that is driven to shield the CMOS 102. The operation controller 206 controls the operation of the shutter unit 104 via the shutter driver 132. The operation controller 206 starts the exposure operation of the CMOS 102 by control of the scan controller 204 and then operates the shutter unit 104 after the set exposure time has been elapsed, thereby performing mechanical shielding of the CMOS 102 and terminating the exposure operation of the CMOS 102.

The scan controller 204 performs exposure start scan of the CMOS 102 by applying reset signals to each of the pixels of the CMOS 102 based on the scan patterns so that the CMOS 102 may serve as a front curtain shutter for starting exposure. The operation controller 206 controls the shutter unit 104 for shielding the CMOS 102 via a rear curtain shutter. In this way, the scan controller 204 controls the electronic front curtain shutter based on the scan patterns according to the photographing condition, and the operation controller 206 controls the mechanical rear curtain shutter, thereby realizing the scan curve shown in graph 63 of FIG. 3 and adjusting exposure.

When an operation of reading each of the pixels of the CMOS 102 is controlled by the scan controller 204, the gain controller 208 controls gain in each predetermined region in synchronization with an operation of reading each of the pixels arranged in a horizontal direction of the CMOS 102 to be controlled by the scan controller 204. The gain controller 208 may control gain in the unit of the pixels of the CMOS 102 and control gain based on a predetermined function that represents a width of variation of gain in synchronization with a position in which the pixels arranged in the horizontal direction of the CMOS 102 are read.

For example, when a read circuit in the unit of a plurality of regions or pixels is installed in a horizontal direction of the CMOS 102 and a gain controlling amplifier is disposed in each of the plurality of regions or pixels, the gain controller 208 controls gain of the gain controlling amplifier in each of the regions.

Also, the gain of a gain controlling circuit disposed in the AFE 106 may be varied in synchronization with reading of pixels arranged in the horizontal direction of the CMOS 102. In this case, the gain controlling circuit may be installed in the AFE 106 in synchronization with a horizontal position of the CMOS 102 or in the imaging signal processor 110 or the TG 108.

Also, the gain controller 208 may vary the gain of the gain controlling circuit disposed in the imaging signal processor 110 in synchronization with reading of the pixels arranged in the horizontal direction of the CMOS 102. In this case, a circuit for providing the amount of variation of gain due to the horizontal direction of the CMOS 102 may be installed in the imaging signal processor 110.

In the present embodiment, gain may be controlled by the gain controller 208 in each predetermined region or pixel. However, the present embodiment is not limited thereto, and a gamma curve may be varied in the unit of regions. The gamma curve is a characteristic curve that represents the ratio of a signal level of an input image and brightness of an output image. The CPU 122 may control the gamma curve, thereby controlling exposure of a scene to be captured.

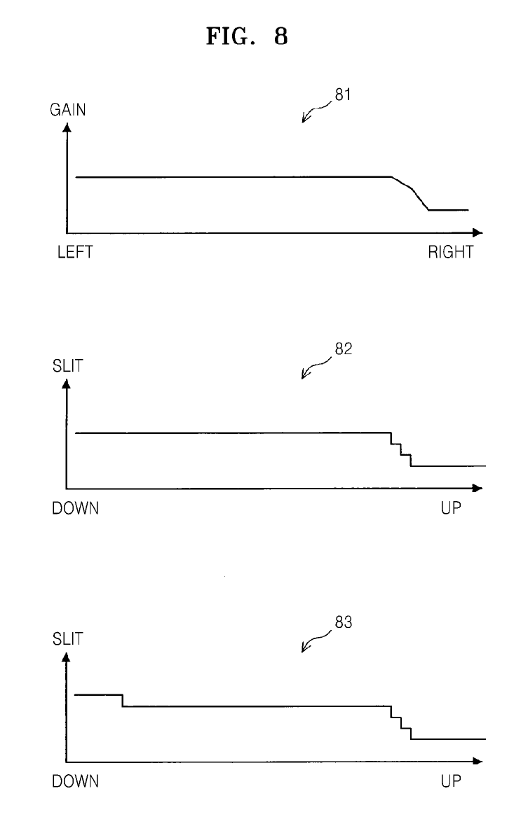

Hereinafter, controlling of gain or a shutter will be described with reference to FIG. 8. FIG. 8 is a graph showing a gain controlling operation and an electronic front curtain shutter controlling operation, which are performed by the photographing apparatus of FIG. 1.

First graph 81 of FIG. 8 shows an example in which gain is varied along a horizontal direction. According to first graph 81, for example, gain of a right portion of a scene is varied to control exposure.

Second graph 82 of FIG. 8 shows an example in which the width of a slit of the electronic front curtain shutter is varied in a vertical direction. In other words, the width of the slit of the electronic front curtain shutter is varied by varying a time at which exposure of the electronic front curtain shutter starts in each pixel line. According to second graph 82, for example, the width of the slit in an upper portion of the scene is reduced.

Third graph 83 of FIG. 8 shows an example in which the width of the slit of the electronic front curtain shutter is increased in the vertical direction. According to third graph 83, the width of the slit of a lower portion of the scene is increased compared to that of second graph 82 so that the amount of exposure of a dark portion of the scene may be increased. In this way, according to the photographing apparatus 10, the time at which exposure of the electronic front curtain shutter starts may be varied in each pixel line so as to vary the width of the slit of the electronic front curtain shutter so that the amount of exposure in the vertical direction may be controlled. Also, with respect to the amount of exposure in the horizontal direction that has not been controlled only by varying the width of the slit of the electronic front curtain shutter, gain may be varied along the horizontal direction and controlled. Thus, exposure may be more accurately controlled.

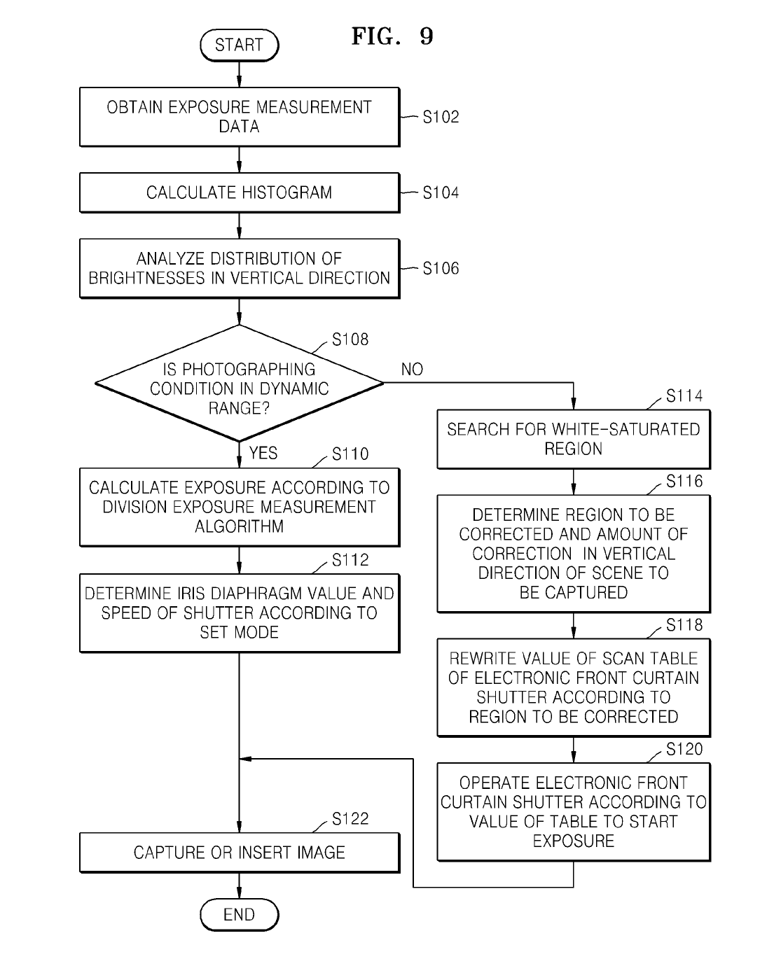

Hereinafter, a photographing method that may be performed by the photographing apparatus 10 (FIG. 4) will be described with reference to FIGS. 9 through 11. FIG. 9 is a flowchart illustrating a photographing method according to an embodiment.

Referring to FIG. 9, in Operation S102, the detector 202 obtains exposure measurement data from an image to be captured. In Operation S104, a histogram is calculated based on the exposure measurement data that is obtained in Operation S102. The histogram calculated in Operation S104 may have the form of graph of FIG. 7, for example. In Operation S106, the distribution of brightness in a vertical direction is analyzed from the histogram calculated in Operation S104. According to the histogram calculated in Operation S104, the distribution of brightness in the image to be captured may be analyzed so that a white-saturated region, a black-squashed region or the like may be detected.

In Operation S108, as a result of analyzing the distribution of brightnesses in a vertical direction in Operation S106, the detector 202 determines whether a photographing condition of a scene to be captured is in the dynamic range (D-range) of an imaging unit. In detail, as described above, whether the photographing condition of the scene to be captured is in the dynamic range (D-range) of the imaging unit is determined depending on whether there is a white-saturated region in an image to be captured due to the surplus of exposure or there is a black-squashed region in the image to be captured due to the lack of exposure.

When it is determined in Operation S108 that the photographing condition of the image to be captured is in the dynamic range of the imaging unit, in Operation S110, exposure is calculated using the exposure measurement data obtained in Operation S102 according to a division exposure measurement algorithm. In Operation S112, an iris diaphragm value and the speed of the electronic front curtain shutter are determined according to a set mode.

In Operation S122, the CPU 122 captures or inserts an image by reading electric charges that are exposed by the imaging unit (CMOS 102) and accumulated due to exposure scan of the electronic front curtain shutter and shielding of the imaging unit (CMOS 102) via the mechanical rear curtain shutter.

On the other hand, when it is determined in Operation S108 that the photographing condition of the scene to be captured is not in the dynamic range of the imaging unit, in Operation S114, the detector 202 searches for the white-saturated region from the scene to be captured. For example, when brightness in the scene to be captured is represented as 256 stages that range from 0 to 255, a region having brightness of 230 to 240 or more may be regarded as the white-saturated region. Similarly, a region having brightness of 10 to 20 or less may be regarded as the black-squashed region.

In Operation S116, the scan controller 204 determines a region to be corrected in a vertical direction of the scene to be captured and the amount of correction from information about the white-saturated region (saturation region) or the black-squashed region that is obtained in Operation S114. In Operation S118, the scan controller 204 rewrites the value of a scan table stored in the scan pattern storing unit (RAM table) 130 based on the region to be corrected and the amount of correction determined in Operation S116. In Operation S120, the electronic front curtain shutter may be operated to start exposure based on the value of the scan table rewritten in Operation S118. Then, Operation S122 is performed. As above, image correction processing using the electronic front curtain shutter has been described.

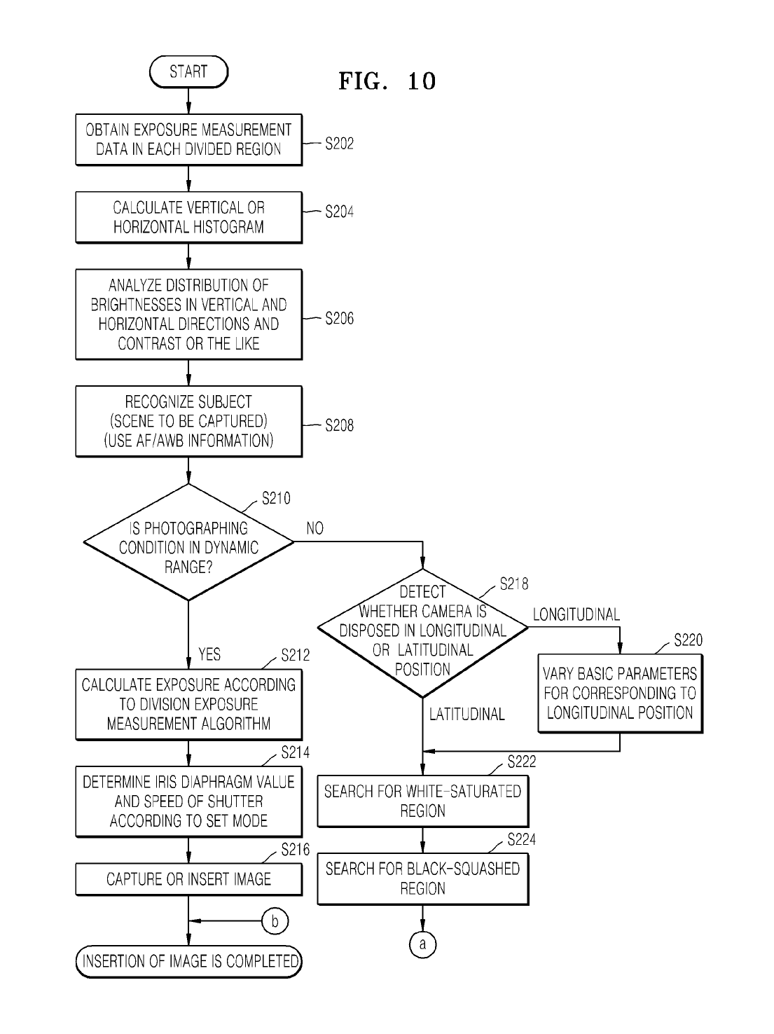

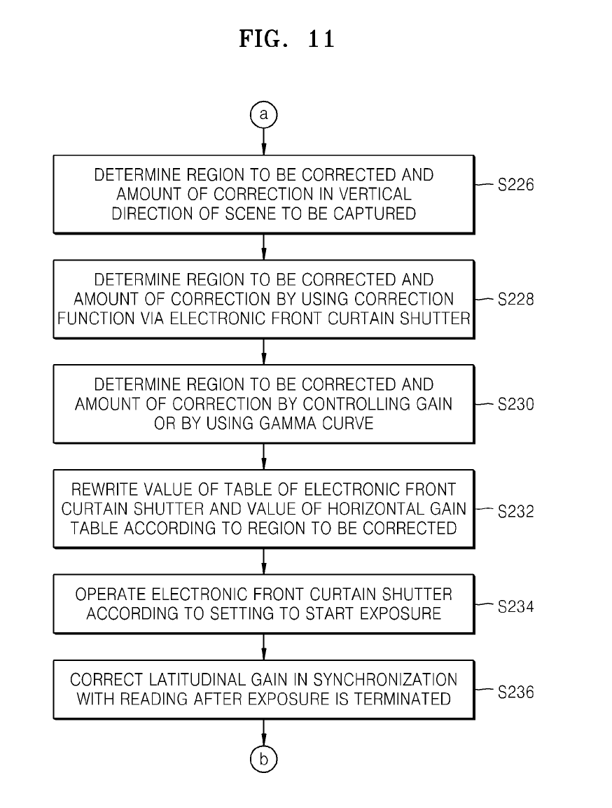

Next, horizontal and vertical image correction processing will be described with reference to FIGS. 10 and 11. FIG. 10 is a flowchart illustrating a photographing method according to another embodiment, and FIG. 11 is a flowchart illustrating operations of the photographing method of FIG. 10.

Referring to FIG. 10, in Operation S202, the detector 202 obtains exposure measurement data from each divided region of a scene to be captured. In Operation S204, a vertical histogram and a horizontal histogram are calculated based on the exposure measurement data that is obtained from each divided region of the scene to be captured in Operation S202.

In Operation S206, the distribution of brightness in horizontal and vertical directions, contrast or the like are analyzed from the vertical and horizontal histograms calculated in Operation S204. In Operation S208, a photographing condition of an image to be captured is recognized from the vertical and horizontal histograms calculated in Operation S204. In Operation S208, AF/AWB information as well as AE information may be used.

In Operation S210, it is determined whether the photographing condition recognized in Operation S208 is in the dynamic range (D-range) of an imaging unit.

When it is determined in Operation S210 that the photographing condition of the image to be captured is in the dynamic range of the imaging unit, in Operation S212, exposure is calculated using the exposure measurement data obtained in Operation S202 according to a division exposure measurement algorithm. In Operation S214, an iris diaphragm value and the speed of the electronic front curtain shutter are determined according to a set mode. In Operation S216, the CPU 122 captures or inserts an image by reading electric charges that are exposed by the imaging unit (CMOS 102) and accumulated due to exposure scan of the electronic front curtain shutter and shielding of the imaging unit (CMOS 102) via the mechanical rear curtain shutter.

On the other hand, when it is determined in Operation S210 that the photographing condition of the image to be captured is not in the dynamic range of the imaging unit, in Operation S218, the detector 202 detects whether a camera is disposed in a longitudinal or latitudinal position. In detail, In Operation S218, the detector 202 detects whether a user photographs while placing the camera in the longitudinal or latitudinal position. In this case, the photographing apparatus 10 includes a sensor for detecting a longitudinal or latitudinal position of a case and thus may detect the longitudinal or latitudinal position of the camera via the sensor.

When it is determined in Operation S218 that the camera is placed in the longitudinal position, in Operation S220, basic parameters for corresponding to the longitudinal position are varied. In detail, the number or range of division of the screen, the division ratio of the screen, the weight of a unit for controlling gain or a shutter or the like are varied. The basic parameters are varied in Operation S220 because, when a screen of the photographing apparatus 10 is rectangular, the division ratio or the area of the screen is varied depending on whether the camera is placed in the longitudinal or latitudinal direction. Also, when exposure is controlled by the shutter, the moving speed of the shutter is varied depending on whether the camera is placed in the longitudinal or latitudinal direction. Thus, the scan speed of the electronic front curtain shutter needs to be varied according to the moving speed of the shutter.

In Operation S222, the detector 202 searches for a white-saturated region from the image to be captured. Also, in Operation S224, the detector 202 searches for a black-squashed region from the image to be captured.

Referring to FIG. 11, in Operation S226, the scan controller 204 determines a region to be corrected in a vertical direction of the scene to be captured and the amount of correction from information about the white-saturated region (saturation region) or the black-squashed region that is obtained in Operations S222 and S224. In Operation S228, the scan controller 204 determines a region to be corrected and the amount of correction from the region to be corrected and the amount of correction determined in Operation S226 by using a correction function via the electronic front curtain shutter. In Operation S230, a region to be corrected and the amount of correction are determined by controlling gain or by using a gamma curve.

In Operation S232, the scan controller 204 rewrites the value of a scan table of the electronic front curtain shutter based on the region to be corrected and the amount of correction determined in Operation S228 and rewrites the value of a horizontal gain table based on the region to be corrected and the amount of correction determined in Operation S230.

In Operation S234, the electronic front curtain shutter may be operated and exposure may start based on the value of the scan table rewritten in Operation S232. In Operation S236, latitudinal gain is corrected in synchronization with reading of electric charges accumulated on the CMOS 102 due to shielding of the CMOS 102 via the mechanical rear curtain shutter after exposure starts in Operation S234. As above, vertical and horizontal image correction processing has been described.

As illustrated in FIG. 9, according to the photographing apparatus 10, the exposure start time of the electronic front curtain shutter may be varied to control the amount of exposure in the vertical direction. Also, as illustrated in FIGS. 10 and 11, with respect to the amount of exposure in the horizontal direction that has not been controlled only by varying the width of the slit of the electronic front curtain shutter, gain may be varied along the horizontal direction and controlled.

For example, each of the operations of the photographing method that may be performed by the photographing apparatus 10 does not need to be performed in a time series format in the order of flowcharts of FIGS. 9, 10, and 11. In other words, each of the operations of the photographing method that may be performed by the photographing apparatus 10 may be changed into other processing or may be performed in parallel.

Furthermore, hardware, such as a CPU, a ROM, a RAM, etc., which is installed in the photographing apparatus 10, may include a computer program for performing the same function as that of each of the elements of the photographing apparatus 10. Also, a non-transitory computer readable storage medium in which the computer program is stored may be provided.

As described above, in a photographing apparatus and method according to the one or more of the above embodiments, both an electronic shutter and a mechanical shutter are used, and a time at which the electronic shutter starts operating is controlled based on a photographing condition so that the photographing apparatus may have a wide dynamic range.

The device described herein may comprise a processor, a memory for storing program data executable by the processor, a permanent storage such as a disk drive, a communications port for handling communications with external devices, and user interface devices, etc. Any processes may be implemented as software modules or algorithms, and may be stored as program instructions or computer readable codes executable on the processor on a non-transitory computer-readable storage media such as read-only memory (ROM), random-access memory (RAM), CD-ROMs, magnetic tapes, floppy disks, and optical data storage devices. The computer readable storage medium can also be distributed over network coupled computer systems so that the computer readable code is stored and executed in a distributed fashion. This computer readable code can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the present invention.

What is claimed is:

1. A photographing apparatus comprising:
an imaging unit that captures an image of a subject, the imaging unit comprising a plurality of pixels arranged in rows and columns;
a detector that detects a photographing condition of the subject;
a mechanical shutter that moves to shield the imaging unit;
an operation controller that controls movement of the mechanical shutter; and
a scan controller that controls an exposure start scan of the imaging unit by applying reset signals to the pixels at a time controlled based on the photographing condition of the subject before the mechanical shutter moves to shield the imaging unit.

2. The photographing apparatus of claim 1, wherein the scan controller sets scan patterns for the photographing condition that is detected by the detector from predetermined scan patterns to correspond to the photographing condition and applies reset signals to the pixels via the set scan patterns.

3. The photographing apparatus of claim 2, wherein the imaging unit serves as a front curtain shutter by starting exposure according to the reset signals applied by the scan controller to the pixels of the imaging unit, and the mechanical shutter serves as a rear curtain shutter for shielding the imaging unit.

4. The photographing apparatus of claim 1, wherein the scan controller divides the imaging unit into a plurality of regions and sequentially starts exposure of the divided regions.

5. The photographing apparatus of claim 1,
wherein the scan controller controls a read scan for reading an output signal of each of the pixels of the imaging unit,
the apparatus further comprising a gain controller that controls gain of the output signal of each of the pixels in synchronization with an operation of reading rows of the pixels via the scan controller.

6. A photographing method for capturing an image of a subject by exposing an imaging unit comprising a plurality of pixels arranged in rows and columns, the method comprising:
detecting a photographing condition of the subject;
performing an exposure start scan by applying reset signals to the pixels at a time controlled based on the photographing condition of the subject and operating a front curtain shutter; and
moving a mechanical shutter to shield the pixels to which the reset signals are applied and operate as a rear curtain shutter.

7. The method of claim 6, further comprising:
setting scan patterns for the photographing condition that is detected from predetermined scan patterns to correspond to the photographing condition,
wherein the performing of the exposure start scan comprises applying reset signals to the pixels via the set scan patterns.

8. The method of claim 6,
wherein the photographing condition comprises brightness of the subject, and
wherein the setting of the scan patterns comprises at least one of
setting the scan patterns in a region in which detected brightness is higher than an upper limit value of a dynamic range of the imaging unit so that a time difference between the front curtain shutter and the rear curtain shutter is decreased, and
setting the scan patterns in a region in which detected brightness is lower than a lower limit value of the dynamic range of the imaging unit so that a time difference between the front curtain shutter and the rear curtain shutter is increased.

9. The method of claim 6, wherein the performing of the exposure start scan comprises sequentially starting exposure of the rows of the pixels.

10. The method of claim 6,
wherein the moving of the mechanical shutter to shield the pixels comprises moving the mechanical shutter in a direction that crosses a direction in which the rows of the pixels extend, and
wherein the scan patterns comprise a characteristic curve for representing an exposure start time of each of the rows from rows of the pixels that correspond to a position in which the mechanical shutter starts moving to rows of the pixels that correspond to a position in which the mechanical shutter terminates moving.

11. The method of claim 6, wherein the performing of the exposure start scan comprises dividing the imaging unit into a plurality of regions and sequentially starting exposure of the divided regions.

12. The method of claim 6, further comprising:
reading an output signal of each of the pixels of the imaging unit; and
controlling gain of the output signal of each of the pixels in synchronization with reading the rows of the pixels.

13. The method of claim 12, wherein the controlling of the gain of the output signal comprises controlling the gain of the output signal in units of the pixels of the imaging unit by referring to a parameter table for representing gain control values respectively corresponding to the rows of the pixels.

14. The method of claim 12, wherein the controlling of the gain of the output signal comprises controlling the gain of the output signal in units of the pixels of the imaging unit based on a function for representing a width of variation of the gain to correspond to the rows of the pixels.
